(19) United States
(12) Patent Application Publication
(10) Pub. No.: US 2002/0038927 A1
(43) Pub. Date: Apr. 4, 2002

(54) Hydraulically damping rubber bearing

(75) Inventor: Wilhelm Mayerbock, Bad Nauenahr (DE)

Correspondence Address: Thomas C. Pontani, Esq., Cohen, Pontani, Lieberman & Pavane, Suite 1210, 551 Fifth Avenue, New York, NY, 10176, US

(73) Assignee: Mannesmann Boge GmbH

(21) Appl. No.: 09/969,359

(22) Filed: Oct. 2, 2001

(30) Foreign Application Priority Data
Oct. 4, 2000 (DE) 100 49 141.3-12

(51) Int. Cl. F16F 1/44; B60G 11/22; F16F 5/00

(52) U.S. Cl. 267/140.12; 267/293

(57) ABSTRACT

Rubber bearing for hydraulically damping axial vibrations with a cylindrical inner part and a concentric outer part a certain distance away, where an elastic element is provided between the inner part and the outer part, and where two damping fluid-filled chambers are located in the elastic element, these chambers being connected to each other by a damping channel. A pump chamber is located at one end of the elastic element, and an equalizing chamber, which accepts the damping fluid arriving through the damping channel without the buildup of pressure, is located at the other end.

### BACKGROUND OF THE INVENTION

1. Field of the Invention

The invention pertains to a rubber bearing for hydraulically damping axial vibrations with a cylindrical inner part and a concentric outer part a certain distance away, where an elastic element is provided between the inner part and the outer part, and where at least two chambers filled with damping fluid are provided in the elastic element, the chambers being connected to each other by a damping channel.

2. Description of the Related Art

Hydraulically damping rubber bearings which have at least two chambers filled with damping fluid in an elastomeric body, one behind the other in the axial direction, are already known (e.g., U.S. Pat. No. 5,165,669). The chambers are separated by a partition wall, in which a flow connection is provided, so that vibrations which develop in the axial direction can be damped. A rubber bearing of this type for absorbing axial vibrations cannot be used in the chassis of a motor vehicle, however, because there is not enough room for it.

### SUMMARY OF THE INVENTION

The object of the invention is to create a hydraulically damping rubber bearing which is able to damp axial vibrations which can be installed in an existing space of narrow dimensions.

According to the invention, a pump chamber is provided at one end of the elastic element, whereas an equalizing chamber, which accepts the damping fluid arriving through the damping channel without the buildup of pressure, is located at the opposite end.

The advantage here is that only one pump chamber is required for the axial damping of the forces, the displaced fluid being accepted by an equalizing chamber at the other end of the rubber bearing. Under compression, the pump chamber conveys the damping fluid from the pump chamber to the equalizing chamber, and under tension, damping medium is conveyed from the equalizing chamber back to the pump chamber. When the rubber bearing is under axial excitation, the change in volume of the pump chamber causes damping fluid to be pumped through the damping channel to the equalizing chamber, which thus realizes the desired damping.

In accordance with another essential feature, it is provided that the pump chamber extends at least part of the way around the circumference.

In an advantageous embodiment, the pump chamber extends all the way around the circumference.

According to one design, the equalizing chamber extends at least part of the way around the circumference.

According to an essential feature, it is provided that the equalizing chamber extends all the way around the circumference.

To reduce the pressure peaks, which can block the damping channel, it is provided in accordance with another design that the pump chamber and the equalizing chamber are connected to each other by a bypass, which parallels the damping channel. It is advantageous to provide the bypass with a check valve. It is thus possible for damping fluid to be let through in only one direction, i.e., from the pump chamber to the equalizing chamber.

Another design provides that the equalizing chamber has a boundary wall at one end, which can stretch at least to some extent. The advantage here is that the elastically stretchable boundary wall acquires the function of an expansion wall and is designed so that the change in volume can be absorbed without any buildup of pressure; in addition, it can also absorb radial stress and possibly even a twisting movement of the rubber bearing.

In a design which is favorable with respect to the production process, the bypass extends diagonally, axially, or radially.

According to an essential feature, the elastic element has a stop and/or a sealing ring to support the outer part. It is advantageous here that the stop and/or the sealing ring can cooperate with the flanged rim of the outer part to produce a leak-tight connection with the inner part via the elastic element between them, where simultaneously the axial stop behavior is also ensured.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a rubber bearing in longitudinal section; and

FIGS. 2 and 3 show cross sections of the rubber bearing of FIG. 1.

### DETAILED DESCRIPTION OF THE PRESENTLY PREFERRED EMBODIMENTS

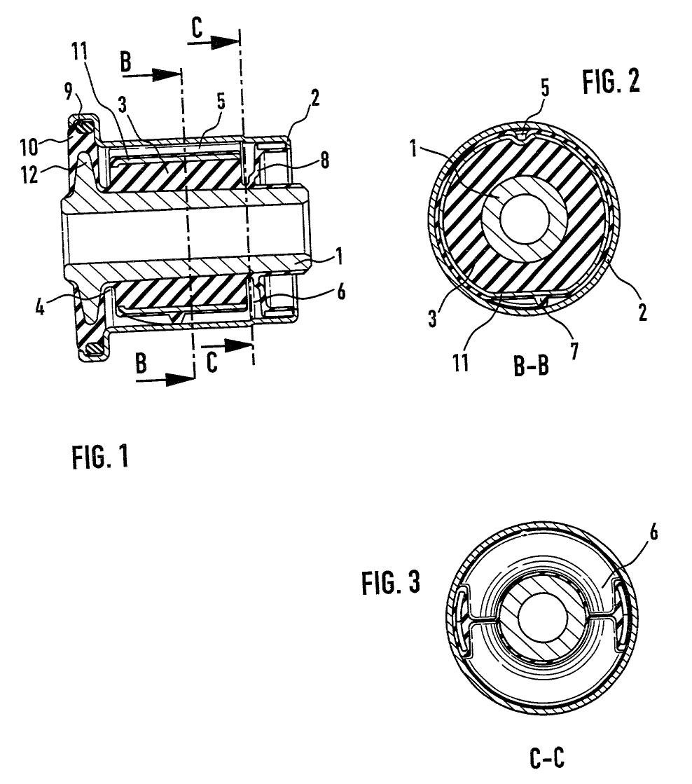

The rubber bearing shown in FIG. 1 consists essentially of the inner part 1, the outer part 2, and the elastic element 3, located between the inner part 1 and the outer part 2. The pump chamber 4 is provided at one end of the elastic element 3, whereas the equalizing chamber 6 is located at the other end. The pump chamber 4 is connected to the equalizing chamber 6 by the damping channel 5. In parallel with the damping channel 5, a bypass 7 is also provided, which equalizes the damping fluid between the pump chamber 4 and the equalizing chamber 6 when pressure peaks occur.

The pump chamber 4 can extend around the entire circumference at the end of the elastic element 3, and it operates axially in both the tension and compression directions. The equalization chamber 6 is provided with a boundary wall 8, which is thin enough that the damping fluid arriving from the pump chamber 4 can be accepted into the equalization chamber 6 without building up any pressure, and any radial or twisting movements which the inner part 1 might make with respect to the outer part 2 can be absorbed.

The elastic element 3 also has a reinforcing tube 11 inside the outer part 2. The damping channel 5 can be easily introduced between the reinforcing tube 11 and the outer part 2, as can be seen in FIG. 2. As FIG. 2 also shows, the bypass 7 is produced by flattening a part of the reinforcing tube 11.

The inner part 1 has a radial extension 12 in the area near the pump chamber 4, which extension supports the side walls of the pump chamber 4. In this area, the elastic element 3 is also provided with a stop 10 and a sealing ring 9, so that a flange-like edging around the outer part 2 guarantees a good seal with respect to the sealing ring 9 and also a good protective cover. Simultaneously, the stop 10 provides the actual stop function with respect to the sealing ring 9.

FIG. 2 shows the inner part 1 and the outer part 2, the equalizing chamber (designed as shown in FIG. 3) being located in the elastic element 3 between the inner and outer parts. Both the bypass 7 and the damping channel 5 are formed between the reinforcing tube 11 and the outer part.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A rubber bearing for hydraulically damping axial vibrations, said bearing comprising
a cylindrical inner part having an axis and a circumference,
an outer part spaced from and concentric to said inner part,
an elastic element between the inner part and the outer part, said elastic element having axially opposed ends, a pump chamber filled with damping fluid at one of said ends, an equalizing chamber filled with damping fluid located at the other of said ends, and a damping channel connecting said chambers so that damping fluid can be transferred from said pump chamber to said equalizing chamber without the buildup of pressure.

2. A rubber bearing as in claim 1 wherein said pump chamber extends at least part way around said circumference.

3. A rubber bearing as in claim 2 wherein said pump chamber extends completely around said circumference.

4. A rubber bearing as in claim 1 wherein said equalizing chamber extends at least part way around said circumference.

5. A rubber bearing as in claim 4 wherein said equalizing chamber extends completely around said circumference.

6. A rubber bearing as in claim 1 further comprising a bypass channel connecting said chambers, said bypass channel being parallel to said damping channel.

7. A rubber bearing as in claim 6 further comprising a check valve in said bypass channel.

8. A rubber bearing as in claim 6 wherein said bypass channel extends one of diagonally, axially, and radially.

9. A rubber bearing as in claim 1 wherein said equalizing chamber comprises a boundary wall which stretches to prevent buildup of pressure when hydraulic fluid is transferred to said equalizing chamber.

10. A rubber bearing as in claim 1 wherein said elastic element comprises at least one of a stop and a sealing ring to support said outer part relative to said inner part.
